(19) United States
(12) Patent Application Publication
(10) Pub. No.: US 2005/0234744 A1
(43) Pub. Date: Oct. 20, 2005

(54) Method and device for securing patient data

(76) Inventor: Karl-Heinz Bauer, Uster (CH)

Correspondence Address: Orum & Roth, 53 West Jackson Boulevard, Chicago, IL, 60604, US

(21) Appl. No.: 10/501,668

(22) PCT Filed: Jan. 15, 2003
(86) PCT No.: PCT/EP03/00364

§ 371 Date: Apr. 20, 2005

(30) Foreign Application Priority Data
Jan. 15, 2002 (DE) 102 01 257.1

(51) Int. Cl. G06F 17/60

(52) U.S. Cl. 705/3

(57) ABSTRACT

The invention relates to a method and device for securing patient data when exchanging information between a patient and a specialist via a data network using computers. The invention involves the use of a first web server, which serves to exchange data pertaining to the individual who is the patient, and of a second web server, which serves to exchange data pertaining to the ailments of the patient.

The invention is based on a method and a device to secure patient data in the case of an exchange of information in accordance with the characterizing portion of claim 1 and of claim 6.

Should a person require medical advice from a specialist, for example from a doctor, he must request an appointment with the relevant specialist and discuss the symptoms of his illness in a personal discussion with the doctor. As a rule, it is not possible for the patient to receive an immediate response to his questions as soon as the complaints emerge. Telephone information is normally not provided. If the person is not in any acute pain and is simply interested in a medical question, the only place he can search for an answer is in the specialist medical literature.

Exchange of patient data between specialists such as doctors or therapists, for example, takes place in personal discussions or in writing. An exchange of patient data with the aid of a computer network does not satisfy the heightened security requirements, since it is not possible to rule out the possibility of the data coming to the knowledge of third parties.

As a result of these disadvantages, the combination of information technology and telecommunications known in an abbreviated form as telematics is not applied within the health care sector.

In contrast, the method according to the invention with the features of claim 1 and the device according to the invention with the features of claim 6 offer the advantage that patient data can be exchanged over a data network, for example the Internet, without this involving any risk that said data could come to the knowledge of third parties in an unauthorized manner. In this way, a patient can put their question to a specialist in the field of medicine, for example. In this process, the patient data is completely anonymized, in order to guarantee the security and confidentiality of the transmitted data. The user or patient provides the information required of him, such as his name, address and possibly his bank account details, by means of a form. The patient is not given the opportunity to enter his complaints or his illness at this point. Entries of these types are suppressed by means of predefined fields in the form. Once the patient has entered his data, an identification number is assigned to him through the Web server and/or the database server. A mailbox is set up for the patient under this identification number, whereby said mailbox can only be used for a specific period of time. At the end of a stipulated period of time, the identification number and the associated mailbox are deleted for security reasons. Should the patient wish to direct a question to a specialist, he is required to first enter his identification number in a second form and then enter the question. The patient does not require an e-mail address for this purpose. It is sufficient for the patient to have Internet access at his disposal. As soon as the patient has sent his question, a check can be run to establish whether the identification number provided is valid and, should payment be required, to determine whether the patient has already paid for his question. Provided that the identification number is valid and payment has been effected, the question is forwarded to a specialist and answered by said specialist. The answer is filed in the mailbox held under the identification number and can be retrieved by the patient upon entering his identification number. For security reasons, the answer in this case appears in an invisible frameset. This eliminates the possibility of the user entering a

URL directly into the address bar and thereby being able to obtain data filed on the servers without actually wishing to.

This strict separation of the data concerning the patient's person and his question makes it possible to ensure that the patient data is sufficiently protected and cannot be viewed without authorization.

To separate the data concerning the person on the one hand and the data concerning the question on the other hand, a first Web server is provided for the personal data and a second Web server for the question data. Each of the two Web servers is connected to the Internet via a router. The first and second Web servers are connected to database servers. This may involve one or more database servers. The first Web server and the second Web server are completely isolated from each other.

A physical separation is provided between the Web servers and the database server. In this way, third parties are prevented from obtaining unauthorized access to the database server's data over the Internet.

In order to increase data security, the database server's data is backed up to an external storage medium at regular time intervals and the data present on the database server is deleted. Should the contents of the database server be subjected to unauthorized access by third parties, access in this case shall be restricted to the data accumulated since the last data backup. An appropriate interval for the creation of data backups is 48 hours, for example.

According to a further preferred embodiment of the invention, the data can be encrypted prior to sending and decrypted upon receipt in order to further increase data security. Known methods of data encryption and cryptography are suitable for this purpose. The device according to the invention can be equipped with a crypto module for encryption and decryption purposes.

The data present on the second Web server and the database server do not have to be correspondingly backed up by means of elaborate data backup processes, since they only contain the identification numbers and the questions, together with the answers relating to the individual cases. Should this data be accessed by unauthorized parties, it would be impossible for the data to be assigned to any specific person. The data therefore requires no stronger protection than a standard mailing list. In contrast, the data on the first Web server is more heavily protected, since it contains personal data, and possibly bank account details.

This elevated level of security for patient data makes it possible to also apply telematics within the health care sector, thereby opening up the possibility of telediagnosis, telepathology, teletherapy and telematics in outpatient care. Patient data can be exchanged not only between the patient and a doctor, but also between doctors, therapists and other specialists. Specialists can refer patients to other doctors or keep them updated. Data that does not relate to a patient can be made available in a database that is freely accessible to users. These kinds of knowledge databases will have an important role to play in the field of medical care. The networking of medical care structures leads to improved and facilitated patient care. In certain circumstances it enables doctor's visits or hospital stays to be avoided. The data network can be divided up into multiple segments, each of which takes into consideration the varied interests of different target groups.

Participation in a platform of this type in a data network involves a multitude of advantages for doctors. Treatment capacities can be better exploited. Up-to-date information improves the level of knowledge required for daily work. The doctor can receive advice with respect to practice management, benchmarking, consulting and separate contracts with health insurance companies. Specialists can join together to create groups. As a group, doctors have decisive advantages, in particular in relation to health insurance companies, industry and legislators. Furthermore, discounts can be obtained for purchasing medical practice supplies.

Patients have the opportunity to join together via the data network to form self-help groups, which can enable the exchange of experiences, knowledge and clinical pictures. Patients may voluntarily reveal their identity for this purpose, though this is not necessary.

According to a preferred embodiment of the invention, a first and a second database server are provided, both of which are connected both to the first and to the second Web server. This separation between the first and the second Web server on the one hand, and the first and the second database server on the other hand, not only increases security with regard to unauthorized access to data but also ensures that the system continues to be functional even in the event of the failure of one of the servers.

The second form for entering the question can present the patient with various preselected subject areas. In this way, the patient is asked to assign his question to a specific field. This makes it easier to answer the questions. The fact that the answers must be phrased in a very general manner and may not take into consideration any individual information means that the answer can be automated. The answers created by the specialists, for example by doctors, are filed in a database and assigned to a defined clinical picture. For a question submitted by a patient, it is sufficient to define the clinical picture and retrieve the answers filed in the database. This serves to greatly minimize editorial effort.

Further advantages and advantageous embodiments of the invention shall be drawn from the following description, the drawing and the claims.

### DRAWING

The drawing shows an example embodiment of the invention, which is described in more detail below. It shows the following:

FIG. 1 Diagrammatic view of the various components of the device according to the invention.

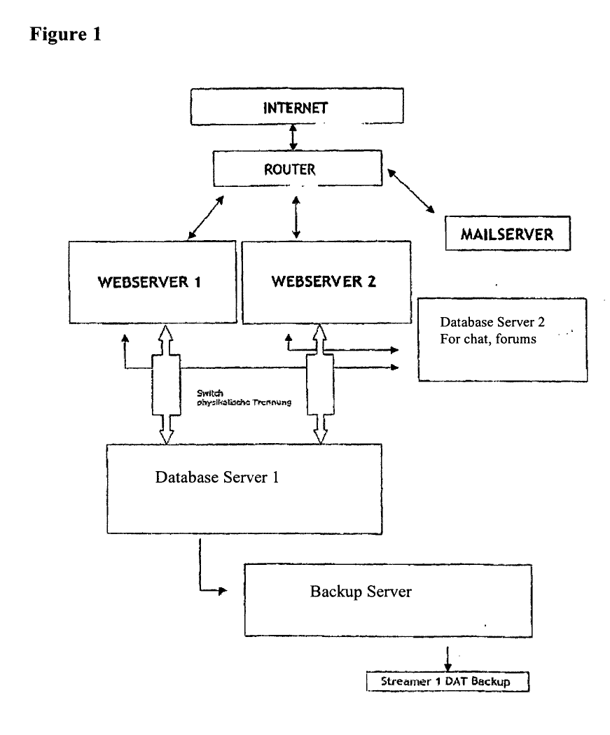

### DESCRIPTION OF THE EXAMPLE EMBODIMENT

The patient's data, his question and the answer are exchanged with the aid of the Internet. The router is situated at the interface between the Internet and the device. From there, the patient's personal data, such as his name and address, for example, reach the first Web server and continue to the first database server. The first database server assigns the patient an identification number and forwards it to the patient via the first Web server and the Internet. The questions with their associated identification numbers and the answers are exchanged and filed via the second Web server. The drawing clearly shows that the first and the second Web servers are completely isolated from each other, as are the first and the second database servers. The second database server is primarily used for discussion groups or forums. Should the first database server fail, then the second database server can take over its tasks.

In order to increase security, physical separation is provided between the two Web servers and the database servers.

With the aid of streamers, backup copies of the data are created via a backup server. The mail server connected to the Internet via the router serves to transmit further data, such as articles on specific topics and advice on nutrition and physical activity, for example. This exchange of data is conducted via e-mail.

All of the features contained in the description, the following claims and the drawing may be material to the invention both individually and in any combination with each other.

1. Method of securing patient data in the case of an exchange of information through a data network with the aid of computers, comprising the steps of
entering the patient's name and address in a first form displayed on a screen of a computer,
assigning the patient an identification number,
displaying the identification number on the screen,
entering the identification number and a question in a second form displayed on the screen,
assigning the answer to the question to the identification number and
displaying the answer to the question on the screen when the identification number is specified.

2. Method of claim 1, further comprising the step of processing and storing the patient's name and address on the one hand and the question and answer on the other hand on separate Web servers and/or separate database servers.

3. Method of claim 1, further comprising the step of deleting the identification number at the end of a stipulated period of time.

4. Method of claim 1, further comprising the steps of saving the patient's name and address filed on a Web server and/or database server to an external data medium at the end of a stipulated period of time and deleting the patient's name and address from the Web server and/or database server.

5. Method of claim 1 further comprising the steps of, encrypting the data is encrypted prior to sending and decrypting the data upon receipt.

6. Method of claim 1, wherein the answer is displayed in an invisible frameset.

7. Device for securing patient data in the case of an exchange of information between a patient and a specialist by means of a data network, in particular for performing the method of claim 1, comprising
a first Web server and a database server connected to the first Web server, through which the patient's name and address are entered and saved, and through which the patient is assigned an identification number,
a second Web server, through which the patient is able to exchange data with a specialist under his identification number, the second Web server is connected to the database server, and the first Web server and the second Web server are isolated from each other.

8. Device of claim 7, wherein physical separation is provided between the first Web server and the database server on the one hand, and between the second Web server and the database server on the other hand.

9. Device of claim 7, further comprising a second database server said second database server is connected to the first and/or the second Web server.

10. Device of claim 7, further comprising a backup unit, which saves the data from the database server to an external data medium at regular intervals of time and deletes the data from the database server.

11. Device of claim 7, further comprising a crypto module for the purpose of encrypting and decrypting the data.

12. Method of claim 2, further comprising the step of deleting the identification number at the end of a stipulated period of time.

13. Method of claim 2, further comprising the steps of saving the patient's name and address filed on a Web server and/or a database server are saved to an external data medium at the end of a stipulated period of time and deleting the patient's from the Web server and/or database server.

14. Method of claim 12, further comprising the steps of saving the patient's name and address filed on a Web server and/or a database server are saved to an external data medium at the end of a stipulated period of time and name and address from the Web server and/or database server.

15. Method of claim 14, further comprising the step of encrypting the data prior to sending and decrypting the data upon receipt.

16. Method of claim 15, wherein the answer is displayed in an invisible frameset.

17. Device for securing patient data in the case of an exchange of information between a patient and a specialist by means of a data network, in particular for performing the method of claim 16, comprising
a first Web server and a database server connected to the first Web server, through which the patient's name and address are entered and saved, and through which the patient is assigned an identification number,
a second Web server, through which the patient is able to exchange data with a specialist under his identification number, the second Web server is connected to the database server, and the first Web server and the second Web server are isolated from each other.

18. Device of claim 17, wherein physical separation is provided between the first Web server and the database server on the one hand, and between the second Web server and the database server on the other hand.

19. Device of claim 8, further comprising a second database server, which is connected to the first and/or the second Web server.

20. Device of claim 18, further comprising a second database server, which is connected to the first and/or the second Web server.
